(19) United States
(12) Patent Application Publication
(10) Pub. No.: US 2014/0200845 A1
(43) Pub. Date: Jul. 17, 2014

(54) Numerical Analysis System

(71) Applicants: Kiyomi Yoshinari, Tokyo (JP); Takuro Kanazawa, Tokyo (JP)

(72) Inventors: Kiyomi Yoshinari, Tokyo (JP); Takuro Kanazawa, Tokyo (JP)

(73) Assignee: Hitachi Ltd., Chiyoda-ku , Tokyo (JP)

(21) Appl. No.: 14/239,403

(22) PCT Filed: Aug. 24, 2011
(86) PCT No.: PCT/JP2011/004683

§ 371 Date: Feb. 18, 2014

(51) Int. Cl. G01N 25/18

(52) U.S. Cl. CPC G01N 25/18
USPC 702/136

(57) ABSTRACT

It is an object of the present invention to analyze heat transfers with a high degree of precision at a computation cost within a realistic range for a large-scale object such as an entire power-electronic system. In order to solve the problems described above, the present invention provides a numerical analysis system based mainly on a configuration for dividing the analysis area into at least two division areas, for analyzing at least one of the division areas by adoption of a finite element method or a boundary element method and for carrying out an analysis by adoption of a technique based on equivalent circuit approximation for at least one of the other division areas.

### TECHNICAL FIELD

The present invention relates to a numerical analysis system for carrying out analyses by combining a plurality of different techniques in the heat-transfer or heat-stress analysis field.

### BACKGROUND ART

With the inverter equipment becoming smaller in size, temperature increases raise a serious problem and the design based on thermal evaluation (that is, the thermal design) in the entire inverter is becoming more important. The temperature increases are caused by decreases of heat-dissipation areas, increases of heat-generation densities or heat-generation increases due to conversions into multi-function equipment. So far, a thermal analysis was carried out for each of components (such as a device, an implementation circuit, a motor and a battery) composing a power-electronic system. In addition, normally, a thermal analysis for an analysis object was carried out by adoption of one analysis technique (such as an FEM or a thermal equivalent circuit analysis).

It is to be noted that patent document 1 is available as a document related to the present technology.

### PRIOR ART DOCUMENT

### Patent Document

Patent document 1: JP-2006-284214-A

### SUMMARY OF THE INVENTION

### Problems to be Solved by the Invention

An area is cut out for each component and a thermal evaluation is carried out for each component. Thus, effects of other areas are not taken into consideration so that the precision of the thermal evaluation carried out for the whole system is not sufficient. In addition, in order to carry out a thermal analysis on the entire power-electronic system by adoption of an FEM, a very high computation cost (that is, a very long time and a very large memory) is incurred so that such a thermal analysis is not practical.

In order to solve the above problems, for a large-scale object such as an entire power-electronic system, it is necessary to provide a high-precision heat-transfer analysis system having a computation cost in a realistic range.

### Means for Solving the Problems

In order to solve the problems described above, the present invention provides a numerical analysis system based mainly on the following configuration.

(1) divide the analysis area into at least two division areas;
(2) analyze at least one of the division areas by adoption of a finite element method or a boundary element method; and
(3) carry out an analysis by adoption of a technique based on equivalent circuit approximation for at least one of the other division areas.

Particularly, in accordance with a method for carrying out an analysis by adoption of a technique based on equivalent circuit approximation, in the case of a heat-transfer analysis, it is desirable for the heat-transfer or heat-stress numerical analysis system according to the present invention to find the thermal resistance R of the analysis area or the admittance Y (=R⁻¹), which is the reciprocal of the thermal resistance R, in advance and, then, compute a temperature change ΔT on a boundary between the division areas included in the analysis area on the basis of a thermal equivalent circuit equation (ΔT=RQ) from a heat quantity Q on the boundary between the division areas included in the analysis area.

In addition, in accordance with a method for finding the thermal resistance R of the analysis area or the admittance Y (=R⁻¹) which is the reciprocal of the thermal resistance R, in advance, if the boundary between the division areas included in the analysis area has at least two locations through which a heat quantity flows out and flows in or at least two locations at which measurements of temperature changes are desired, it is desirable to find a thermal resistance matrix [R] of the division area or an admittance matrix [Y] (=[R]⁻¹) which is the inverse matrix of the thermal resistance matrix [R], in advance and, then, compute a temperature change sequence [ΔT] on the boundary between the division areas included in the analysis area on the basis of a thermal equivalent circuit equation ([ΔT]=[R][Q]) from a heat quantity sequence [Q] on the boundary between the division areas included in the analysis area.

In addition, in accordance with a method for carrying out an analysis by adoption of the technique based on equivalent circuit approximation, in the case of a heat-stress analysis, after a temperature change ΔT on the boundary between the division area included in the analysis area or a temperature change sequence [ΔT] on the boundary between the division areas included in the analysis area has been computed on the basis of the thermal equivalent circuit equation, it is desirable to further make use of the temperature changes for finding a stress generated by thermal expansion or thermal contraction.

In addition, in accordance with a method for dividing the analysis area into at least two division areas, it is desirable to divide the analysis area into a division area having an unchanging shape and a division area having a changeable shape, take the division area having an unchanging shape as an object of an analysis adopting the technique based on equivalent circuit approximation and take the division area having a changeable shape as an object of an analysis adopting the finite element method or the boundary element method.

In addition, in accordance with the method for dividing the analysis area into at least two division areas, it is desirable to divide the analysis area into a division area having at least one heat source and a division area having no heat source, take the division area having no heat source as an object of an analysis adopting the technique based on equivalent circuit approximation and take the division area having at least one heat source as an object of an analysis adopting the finite element method or the boundary element method.

In addition, with regard to a thermal resistance R of the analysis area, a thermal resistance matrix [R] of the analysis area, an admittance Y which is the reciprocal of the thermal resistance R or an admittance matrix [Y] which is the inverse matrix of the thermal resistance matrix [R], after the value of the thermal resistance R or the value of the thermal resistance matrix [R], or the value of the admittance Y or the value of the admittance matrix [Y] have been once found, it is desirable to store the values in a database (DB) for later utilizations.

In addition, in accordance with a method for carrying out an analysis by adoption of the technique based on equivalent circuit approximation, it is desirable to further finely divide the division area taken as an analysis execution object of the technique based on equivalent circuit approximation into a plurality of fraction areas (or fraction division areas), find a thermal resistance R of the fraction area or a thermal resistance matrix [R] of the fraction area, or an admittance Y which is the reciprocal of the thermal resistance R or an admittance matrix [Y] which is the inverse matrix of the thermal resistance matrix [R] for each of the fraction areas of the division area and synthesize the values of the thermal resistance R, the thermal resistance matrix [R], the admittance Y and the admittance matrix [Y] in order to find, for the division area serving as an object of the analysis carried out by adoption of the technique based on equivalent circuit approximation, a thermal resistance R or a thermal resistance matrix [R], or an admittance Y or an admittance matrix [Y].

In addition, in accordance with a method for further dividing the division area taken as an analysis execution object of the technique based on equivalent circuit approximation into a plurality of fraction areas, with regard to either of an index and a unit which are used for dividing the division area into the fraction areas, it is desirable to divide the division area by making use of a component or a component including its peripherals as a unit of one fraction area or divide the division area into fraction areas each having an unchanging shape and areas each having a changeable shape.

In addition, in accordance with a method for further dividing the division area taken as an analysis execution object of the technique based on equivalent circuit approximation into a plurality of fraction areas, as an index used for dividing the division area into the fraction areas, with regard to the division area used as the object of an analysis carried out by adoption of the technique based on equivalent circuit approximation, it is desirable that the number of fraction area division lines approximately perpendicular to the direction of a main heat flow from an inflow portion to an outflow portion of main heat is set to a value equal to or greater than the number of fraction area division lines approximately parallel to the direction of the main heat flow.

In addition, in accordance with a method for dividing an analysis area into at least two division areas, analyzing at least one of the areas by adoption of a finite element method or a boundary element method and carrying out an analysis by adoption of the technique based on equivalent circuit approximation for at least one of the other division areas, it is desirable to pass on an analysis result obtained in any specific one of the division areas, across a boundary between the specific division area and the other division area, as a boundary value of the next analysis in the other division area and carry out combined analyses so as to assure the preservation and consistency of physical quantities.

In addition, in accordance with a method for dividing an analysis area into at least two division areas, analyzing at least one of the division areas by adoption of a finite element method (FEM) or a boundary element method (BEM) and carrying out an analysis by adoption of the technique based on equivalent circuit approximation for at least one of the other division areas, it is desirable to, first, for a division area to be analyzed by adoption of the finite element method or the boundary element method, find a heat-flux (q) distribution and a temperature-change (ΔT) distribution in the inside and on the boundary of the division area serving as an object of the finite element method or the boundary element method by setting a temperature change ΔT on the boundary with a division area to be analyzed by adoption of the technique based on equivalent circuit approximation to 0 (ΔT=0) in an initial setting operation, find a heat quantity Q_{B} of the boundary with the division area to be analyzed by adoption of the technique based on equivalent circuit approximation on the basis of the heat flux distribution and the temperature change (ΔT) distribution from the heat-flux (q) distribution, then compute a temperature change ΔT_{B} on the boundary of the division area from the heat quantity Q_{B} of the boundary on the basis of a thermal equivalent circuit equation ([ΔT]=[R][Q]) for a division area to be analyzed by adoption of the technique based on equivalent circuit approximation, and add the values of a temperature-change (ΔT_{B}) distribution on the boundary of the division area to a ΔT distribution obtained by carrying out an analysis based on the finite element method or the boundary element method with the temperature change ΔT on the boundary set to 0 (ΔT=0) in an initial setting operation, in order to find a temperature-change (ΔT) distribution.

In addition, in accordance with a method for dividing an division area at least two division areas, analyzing at least one of the division areas by adoption of a finite element method or a boundary element method and carrying out an analysis by adoption of the technique based on equivalent circuit approximation for at least one of the other division areas, it is desirable to set a heat quantity Q calculated from all heat sources existing in the entire system as a heat quantity Q on a boundary between a division area to be analyzed by adoption of the finite element method or the boundary element method and a division area to be analyzed by adoption of the technique based on equivalent circuit approximation, compute a temperature change ΔT on the boundary of the division area from the heat quantity Q on the basis of a thermal equivalent circuit equation (ΔT=RQ) for the division area serving as an object to be analyzed by adoption of the technique based on equivalent circuit approximation, take the temperature change ΔT on the boundary as an initial condition and compute a heat-flux (q) distribution and a temperature-change (ΔT) distribution in the inside and on the boundary of a division area serving as an object of the finite element method or the boundary element method.

In addition, in accordance with a method for passing on an analysis result obtained in any specific one of the division areas, across a boundary between the specific division area and the other division area, as a boundary value of the next analysis in the other division area and carrying out combined analyses so as to assure preservation and consistency of physical quantities, it is desirable to repeatedly perform iterative computations to carry out a combined analysis combining an analysis adopting the finite element method or the boundary element method with an analysis based on the equivalent circuit approximation at least two times.

In addition, in accordance with a method for iteratively carrying out a combined analysis combining an analysis adopting the finite element method or the boundary element method with an analysis based on the equivalent circuit approximation at least two times, it is desirable to find a residual error of the most recent temperature change ΔT on a boundary, the temperature change ΔT found by adoption of techniques for division areas and pass on a sum obtained by adding a product obtained by multiplying the residual error by a relaxation coefficient ω (≦1) to a value of an immediately previous analysis or an analysis preceding the immediately previous analysis as a boundary value of the next analysis.

In addition, in accordance with a method for finding a residual error of the most recent temperature change ΔT on a boundary, the temperature change ΔT found by adoption of techniques for division areas and passing on a sum obtained by adding a product obtained by multiplying the residual error by a relaxation coefficient ω (≦1) to a value of an immediately previous analysis or an analysis preceding the immediately previous analysis as a boundary value of the next analysis, it is desirable to change the value of the relaxation coefficient ω in the course of the iterative computations to carry out the combined analysis.

In addition, in accordance with a method for changing the value of the relaxation coefficient ω in the course of the iterative computations to carry out the combined analysis, it is desirable to change the value of the relaxation coefficient ω in the course of the iterative computations so as to set the relaxation coefficient ω to a small value (ω≦0.5) when the number of aforementioned iterative computations is small or a large value (0.5<ω≦1.0) when the number of aforementioned iterative computations increases.

In addition, if a PC cluster, a multi-core PC or a multi-thread PC is used as means for carrying out analysis computations, it is desirable to assign a division area and computation for every division area to each PC, each core or each thread in order to raise the speed of the whole computations.

In addition, for a heat-transfer or heat-stress analysis, even in the case of a quantity other than a physical quantity serving as an analysis object, in the same way as the heat analysis, a physical quantity having a field describable by a scalar potential is analyzed.

In accordance with a method for dividing an analysis area into at least two division areas or with a method for further finely dividing the division area taken as an object of an analysis executed by adoption of the technique based on equivalent circuit approximation into a plurality of fraction areas, with regard to division of the analysis area into division areas and division of a division area into fraction areas, it is desirable to provide a user interface function to be used by a user carrying out analyses to enter or set information.

### Effects of the Invention

For a large-scale object such as an entire power-electronic system, the present invention provides a high-precision heat-transfer analysis system having a computation cost in a realistic range.

### BRIEF DESCRIPTION OF THE DRAWINGS

FIG. 1 is a rough diagram showing a numerical analysis flow in a first embodiment of the present invention;

FIG. 2 is a rough diagram showing a processing flow in a numerical analysis system according to the first embodiment of the present invention;

FIG. 3 is a diagram showing the hardware configuration of a numerical analysis system according to the present invention;

FIG. 4 is a rough diagram for the first embodiment of the present invention;

FIG. 5 is a conceptual diagram to be referred to in description of an analysis technique adopted in a division area serving as an object of an analysis based on equivalent circuit approximation according to the present invention;

FIG. 6 is a diagram showing results of a numerical analysis carried out by making use of the first embodiment of the present invention;

FIG. 7 is a rough diagram showing a numerical analysis flow in a second embodiment of the present invention;

FIG. 8 is a rough diagram for the second embodiment of the present invention;

FIG. 9 is a diagram showing results of a numerical analysis carried out by making use of the second embodiment of the present invention;

FIG. 10 is a rough diagram for a third embodiment of the present invention;

FIG. 11 is a conceptual diagram to be referred to in description of an analysis technique for a case in which in a division area serving as an object of an analysis based on equivalent circuit approximation according to the present invention is further divided into fraction areas;

FIG. 12 is a diagram showing results of a numerical analysis carried out by making use of the third embodiment of the present invention;

FIG. 13 is a rough diagram for a fourth embodiment of the present invention;

FIG. 14 is a rough diagram showing a numerical analysis flow in a fifth embodiment of the present invention;

FIG. 15 is a rough diagram showing a numerical analysis flow in a sixth embodiment of the present invention;

FIG. 16 is a diagram showing results of a numerical analysis carried out by making use of the sixth embodiment of the present invention;

FIG. 17 is a rough diagram showing a numerical analysis flow in a seventh embodiment of the present invention; and

FIG. 18 is a diagram showing results of a numerical analysis carried out by making use of the seventh embodiment of the present invention.

### MODE FOR CARRYING OUT THE INVENTION

Embodiments of the present invention are described by referring to the diagrams as follows.

First of all, a first embodiment is described.

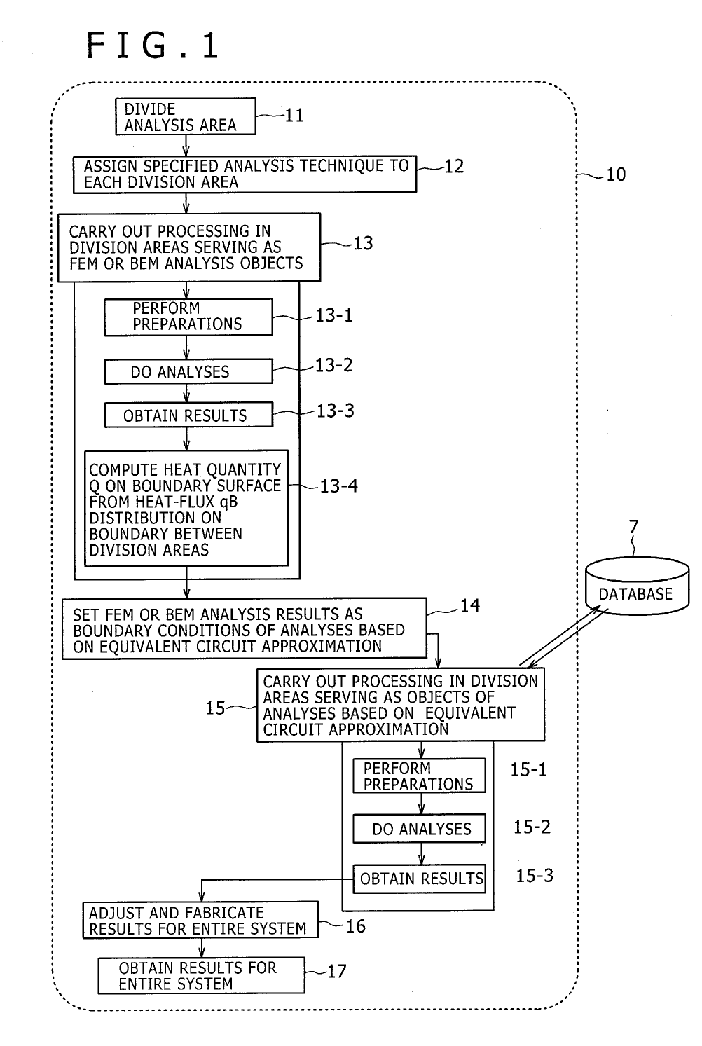

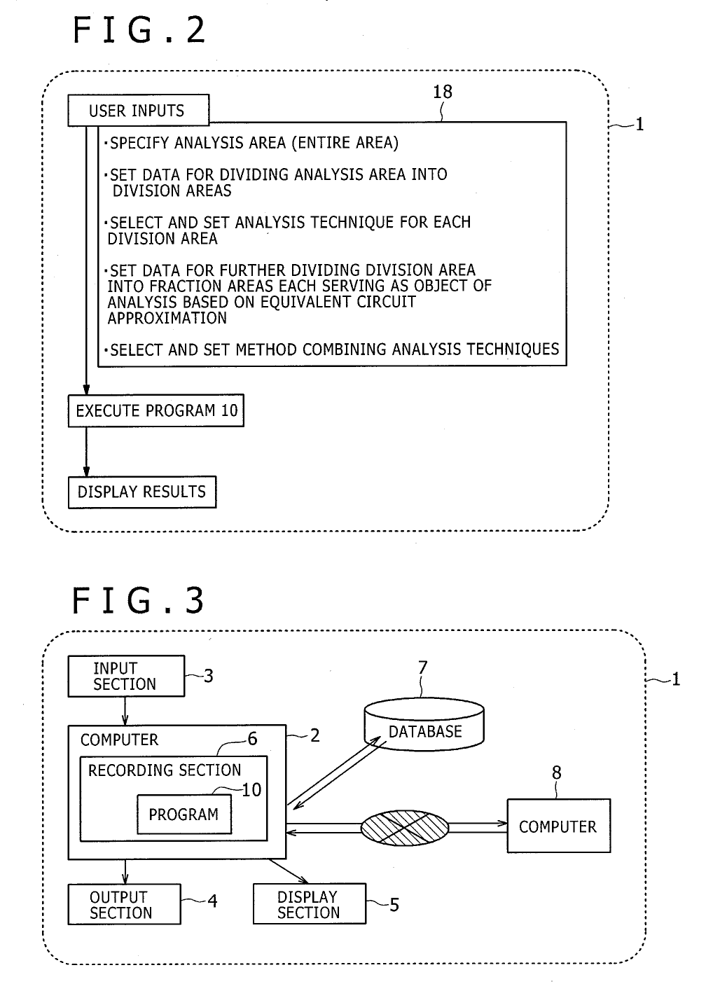

FIG. 1 shows the processing flow of a numerical analysis program according to the present invention whereas FIG. 2 shows the processing flow of the entire numerical analysis system to indicate a characteristic of the present invention.

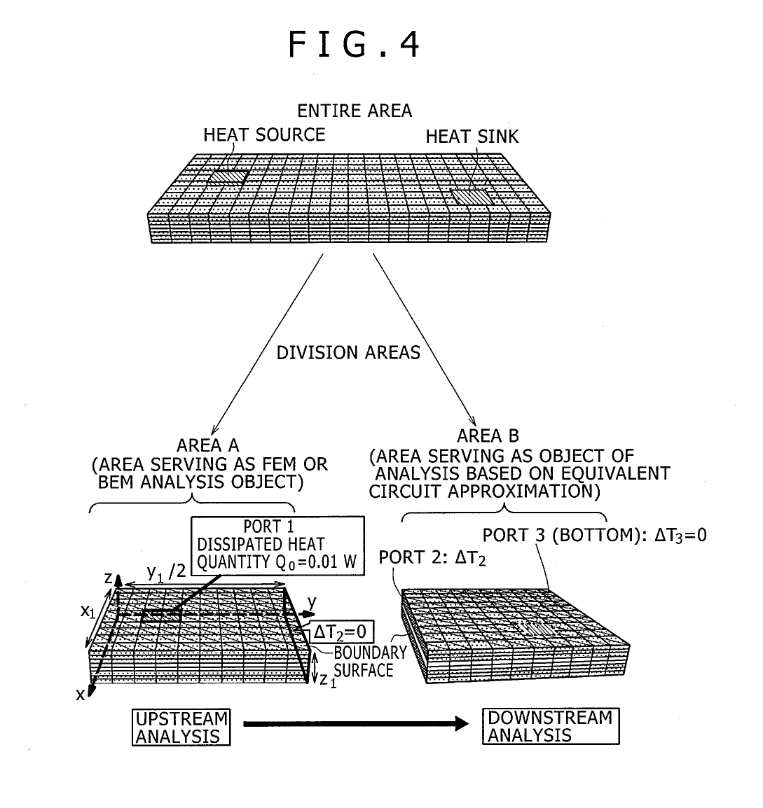

In addition, FIG. 3 shows the hardware configuration of the numerical analysis system whereas FIG. 4 shows an outline of the present invention.

First of all, by referring to FIG. 3, the hardware configuration of the embodiment is explained. The numerical analysis system 1 according to this embodiment has a hardware configuration comprising a computer 2, an input section 3, an output section 4, a display section 5, a recording section 6 and a database 7. In this case, the output section 4 and the display section 5 can be integrated to form a section.

A program 10 to be executed to carry out a numerical analysis according to the present invention is stored in the recording section 6 such as a hard disk. The numerical analysis is carried out as processing based on the present invention. The recording section 6 is incorporated in the computer 2. The program 10 is executed to carry out a numerical analysis according to the present invention as processing based on the present invention by making use of the processing power of the computer 2 or another computer 8 connected to the computer 2 by a network 9.

In this case, the computer 2 or 8 is a general computer capable of carrying out numerical processing. Examples of the general computer are a PC, a PC cluster, a multi-core PC, a multi-thread PC or a supercomputer. A user carrying out a numerical analysis makes use of the input section 3 in order to create a model of a numerical analysis object and enter necessary analysis conditions. Then, the numerical analysis is carried out and results of the analysis are output to the output section 4 and displayed on the display section 5.

Next, the processing flow of the numerical analysis system 1 according to this embodiment is explained by referring to FIG. 1 whereas the processing flow of the program 10 executed to carry out a numerical analysis according to the present invention as processing based on this embodiment is explained by referring to FIG. 2.

First of all, the flow of large processing carried out by the entire numerical analysis system 1 is explained by referring to FIG. 2. The large processing is carried out as follows. As a user input 18, the user specifies an analysis object area (a whole area) and sets conditions for dividing the whole area into a plurality of large areas as inputs. (An example of the conditions is a condition specifying area division lines). In addition, the user selects an analysis technique for each of the large areas and sets conditions for the large areas. The user also specifies settings for a case in which an analysis object area based on equivalent circuit approximation is further finely divided into fraction areas and selects an analysis technique for each of the fraction areas. Then, the user enters the settings and makes a request for execution of the program 10 in order to carry out the numerical analysis according to the present invention. Finally, results of the numerical analysis are displayed.

Next, detailed processing of the program 10 executed to carry out the numerical analysis according to the present invention is explained by referring to FIG. 1. On the basis of the conditions specified as a user input 18, area division processing 11 is carried out in order to divide the whole analysis area into division areas. Then, an analysis technique specified by the user is assigned to each of the division areas (12). At that time, an analysis technique based on equivalent circuit approximation is assigned to at least one area. For each of the other areas, an FEM or BEM analysis technique is selected.

As an example, FIG. 4 shows a typical application to a system including a heat source, a heat sink and copper wires sandwiched by insulation materials such as FR4. In this example, the analysis area of the entire system is divided into two division areas as shown in FIG. 4. The division area including the heat source is taken as an FEM or BEM object area whereas the division area including the heat sink is taken as a division area serving as an object of an analysis based on equivalent circuit approximation.

This embodiment is characterized in that processing 13 inside the division area taken as an FEM or BEM analysis object is carried out first and, later, processing 15 inside the division area taken as an object of an analysis based on equivalent circuit approximation is carried out. To put it concretely, in the processing 13 carried out in the FEM or BEM object area (referred to as a division area A), a preparation 13-1 is implemented in order to create, among others, a computation model for the object division area and a mesh for the area. At that time, particularly, a temperature change is tentatively set in an initial operation (ΔT_{B}=0) as a condition on a boundary between the large division areas. Then, on the basis of the preparation 13-1, an FEM or BEM analysis 13-2 is carried out and, for results 13-3 obtained from the analysis 13-2, a heat quantity Q_{B}, on the boundary surface is computed from a heat-flux (q_{B}) distribution on the boundary between the large division areas by adoption of typically a method such as surface integration of the heat flux q_{B}. The heat quantity Q_{B}, is then passed on to the other area (referred to as a division area B) as a boundary condition of an analysis carried out in the other area B (processing 14).

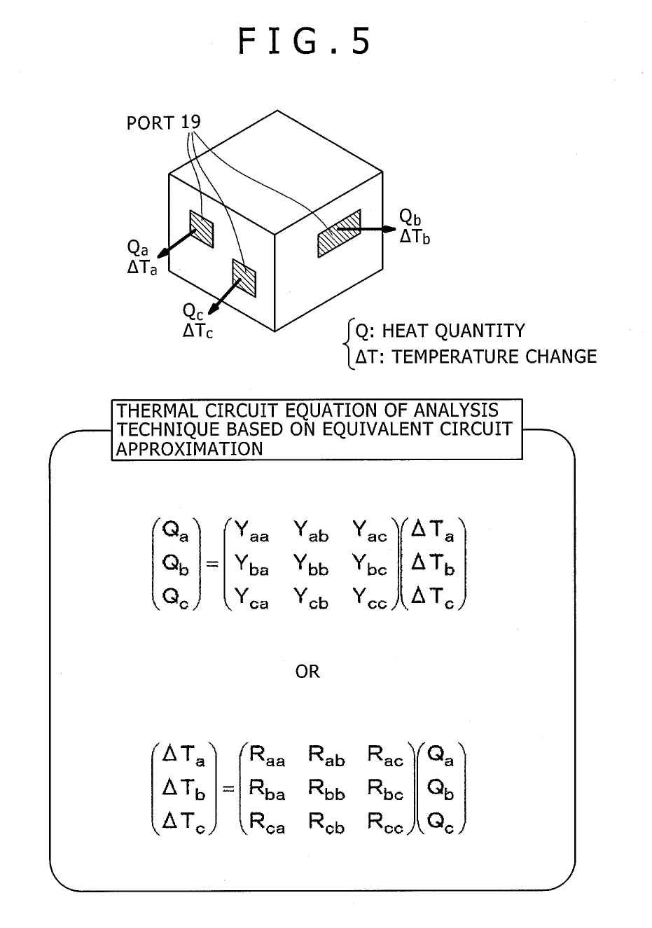

Next, by referring to FIG. 5, the following description explains a technique for carrying out the processing 15 in the division area (referred to as the area B) serving as an object of an analysis based on equivalent circuit approximation.

If a copper-wire cross section is exposed on a boundary surface of the division area (the area B) selected to serve as an object of an analysis based on equivalent circuit approximation as shown in FIGS. 4 and 5, the heat conductivity of the copper-wire cross section is larger by an order of 3 digits than the heat conductivity of an insulation material surrounding the copper-wire cross section. Thus, assuming that heat is transferred from this area to the other area only through the copper-wire cross sections, these copper-wire cross sections are each referred to as a port 19. The port 19 plays a role as one like a terminal capable of transferring heat to the other area. For this port, a thermal circuit equation [ΔT]=[R][Q] in the area is found. In this case, notation [ ] denotes a numerical sequence or a matrix. If notation [ ] denotes a numerical sequence, the size of the sequence is Np or (Np−1) where symbol Np denotes the number of ports. If notation [ ] denotes a matrix, on the other hand, the size of the matrix is Np×Np or (Np−1)×(Np−1).

That is to say, in accordance with the analysis method, the thermal resistance matrix [R] of the area or the thermal-admittance matrix [Y]=[R]⁻¹ which is the inverse matrix of the thermal resistance matrix [R] is found and then the heat quantity Q of each port is substituted into the thermal circuit equation [ΔT]=[R][Q] in order to compute the temperature change ΔT of each port from the thermal circuit equation [ΔT]=[R][Q]. In accordance with this method, the heat flow through a port can be expressed truly without regard to the complexity in the block. In addition, after the thermal resistance matrix [R] of the area or the thermal-admittance matrix [Y]=[R]⁻¹ which is the inverse matrix of the thermal resistance matrix [R] has been once found, the temperature change ΔT can be computed merely as matrix computation according to the thermal circuit equation [ΔT]=[R][Q]. Thus, the temperature change ΔT can be evaluated at a very high speed.

Next, on the basis of the analysis method explained above, the following description explains the processing 15 in the area B which is a division area serving as an object of an analysis based on equivalent circuit approximation. Preparation 15-1 in this processing includes preparations such as creation of a computation model of the area and mesh generation. Then, in an analysis 15-2, the thermal resistance matrix [R] of the area or the thermal-admittance matrix [Y]=[R]⁻¹ which is the inverse matrix of the thermal resistance matrix [R] is found only once. Subsequently, on the basis of the thermal circuit equation [ΔT]=[R][Q], the temperature change ΔT_{B} of the boundary-surface port is computed from the thermal resistance matrix [R] and the heat quantity Q_{B}, of the boundary-surface port. In this case, the heat quantity Q_{B}, has already been obtained as a result of the analysis carried out on the area A.

In this case, as a point to be particularly noted, the thermal resistance matrix [R] of the area or the thermal-admittance matrix [Y]=[R]⁻¹ which is the inverse matrix of the thermal resistance matrix [R] needs to be found only once in an analysis 15-2 only if the shape of the area does not change.

Thus, after the thermal resistance matrix [R] of the area or the thermal-admittance matrix [Y]=[R]⁻¹ which is the inverse matrix of the thermal resistance matrix [R] has been found once, the thermal resistance matrix [R] or the thermal-admittance matrix [Y]=[R]⁻¹ can be stored in the database 7. Then, when an analysis based on the equivalent circuit approximation is carried out on a division area having the same shape, the thermal resistance matrix [R] or the thermal-admittance matrix [Y]=[R]⁻¹ which is the inverse matrix of the thermal resistance matrix [R] is retrieved from the database 7 and can be used several times. Thus, an increase of the speed of the analysis can be expected.

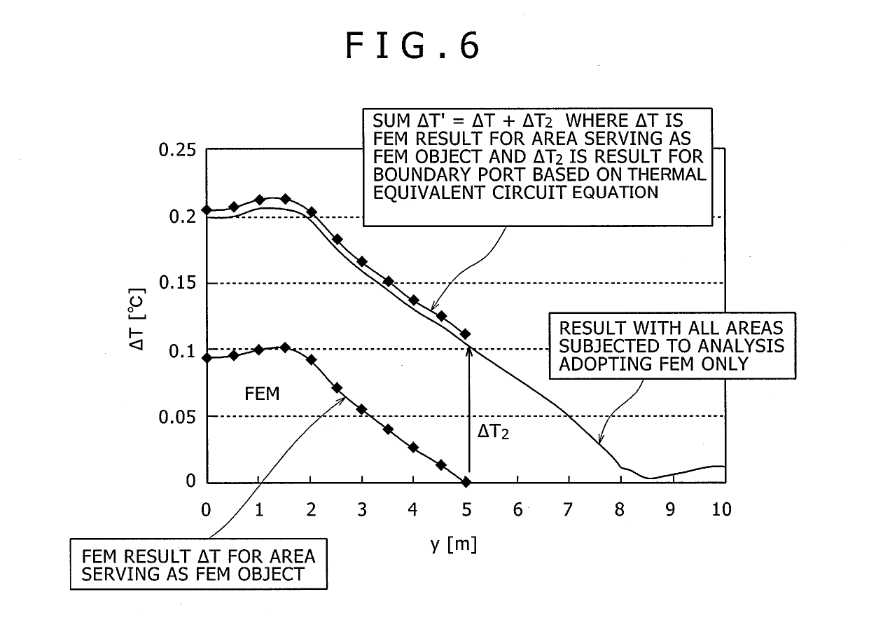

The temperature changes ΔT_{B} of the ports on the boundary surface are results 15-3 obtained from the processing described above. From the temperature changes ΔT_{B}, in order to assure the preservation and consistency of physical quantities, values of a temperature change (ΔT_{B}) distribution on the boundary of the analysis area are added to values of a temperature change (ΔT) distribution obtained as a result of an analysis carried out by adoption of the finite element method or the boundary element method with ΔT_{B}=0 set in initialization of the temperature changes on the boundary and, then, fabrication/adjustment processing 16 is carried out on the temperature change distribution in order to generate a combined analysis result 17 for the entire system, that is, in order to generate a temperature change T′=ΔT+ΔT_{B}. At that time, a result obtained by actually making use of the embodiment is shown in FIG. 6. It is possible to verify that the result obtained by making use of the embodiment agrees with a result of computation carried out on the entire system by adoption of the FEM with errors within a range of 10%.

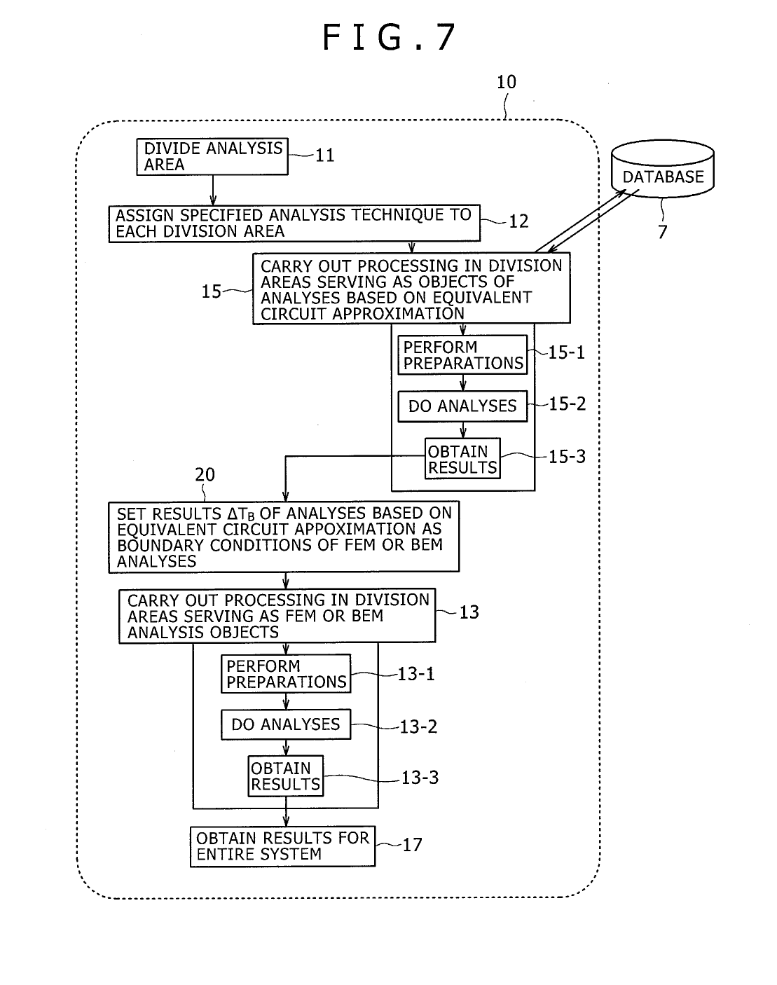

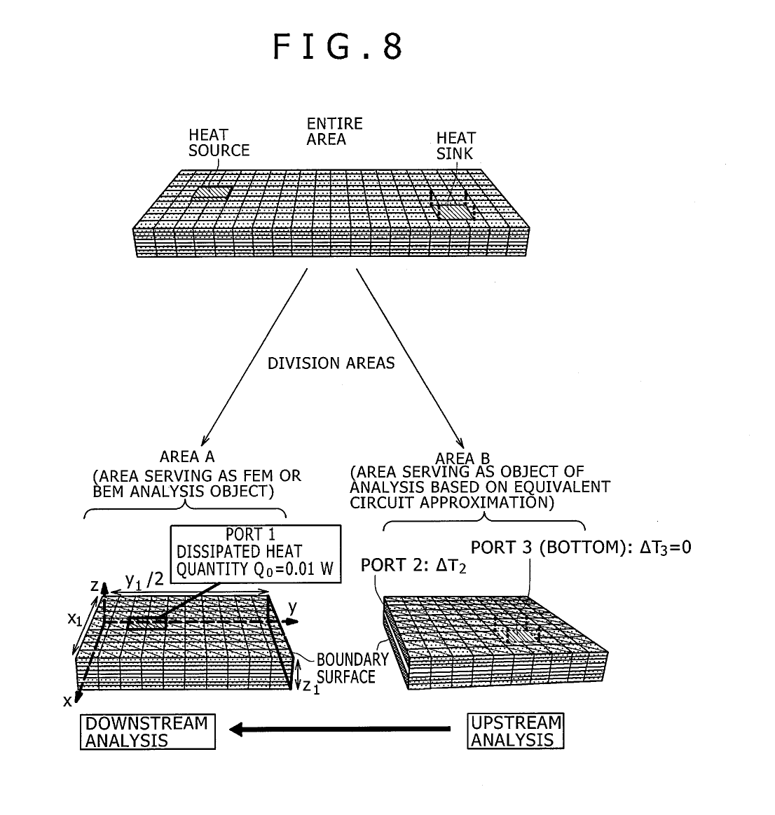

Next, a second embodiment of the present invention is explained by referring to FIGS. 7, 8 and 9. In this case, as shown in FIGS. 7 and 8, the relation between the upstream analysis and the downstream analysis is opposite to the relation for the first embodiment.

That is to say, the second embodiment is characterized in that the processing 15 for the division area serving as an object of an analysis based on equivalent circuit approximation is carried out first whereas the processing 13 for the division area serving as an object of an analysis adopting the FEM or the BEM is carried out later. To put it concretely, the heat quantity Q on the boundary between the area A (which is a division area to be analyzed by adoption of the finite element method or the boundary element method) and the area B (which is a division area to be analyzed by adoption of a technique based on equivalent circuit approximation) is set to a heat quantity Q calculated from all heat sources existing in the entire system and, thus, first of all, a temperature change ΔT_{B} on the boundary of the object division area (the area B) is computed from the heat quantity Q on the basis of a thermal equivalent circuit equation (ΔT=RQ) for the object division area (the area B) to be analyzed by adoption of the technique based on equivalent circuit approximation by carrying out the processing 15 in the division area (the area B) for the object division area (the area B) and passed on to the other object division area (area A) as a boundary condition of the analysis in processing 20.

Then, by making use of the temperature change ΔT_{B} on the boundary as a boundary initial condition, the processing 13 in the division area serving as an object of an FEM analysis carried out by adoption of the finite element method or an object of a BEM analysis carried out by adoption of the boundary element method is performed in order to compute a heat-flux (q) distribution and a temperature-change (ΔT) distribution for the inside and boundary of the object division area (the area A).

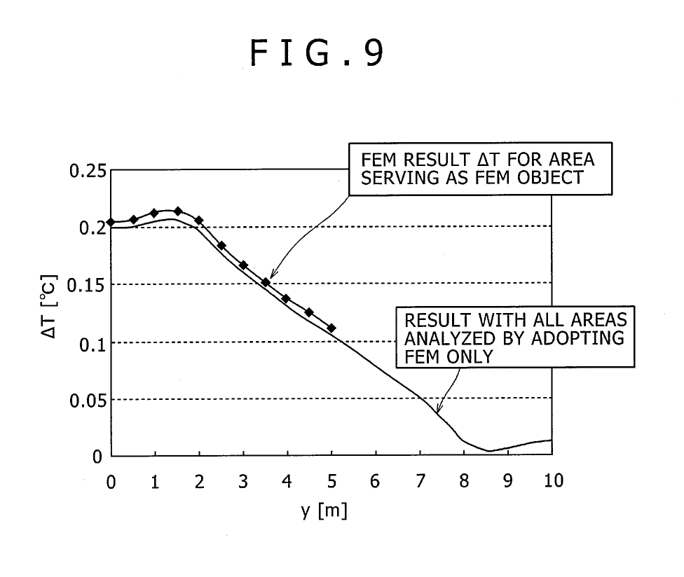

As shown in a processing flow of FIG. 7, in accordance with this embodiment, the processing 13 inside the division area serving as an FEM or BEM analysis object does not require the adjustment processing 16 which is needed in the processing flow of the first embodiment. This is because the boundary initial condition ΔT_{B} is already a result of an analysis technique based on equivalent circuit approximation. In addition, at that time, a result obtained by actually making use of the embodiment is shown in FIG. 9. It is possible to verify that the result obtained by making use of the embodiment agrees with a result of computation carried out on the entire system by adoption of the FEM with errors within a range of 10%.

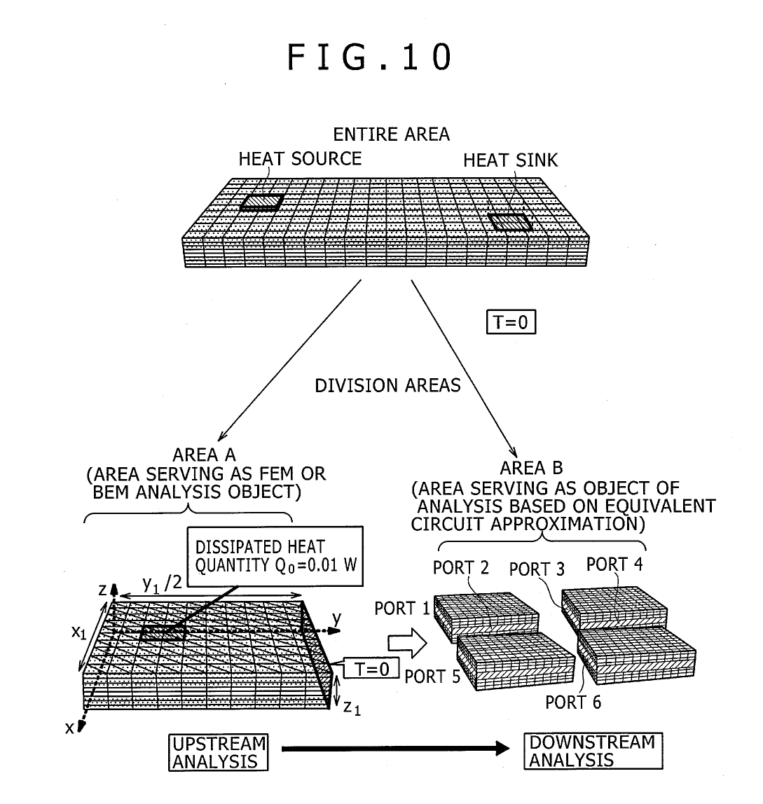

Next, a third embodiment of the present invention is explained by referring to FIGS. 10, 11 and 12. The third embodiment is characterized in that the division area B is further divided into fraction areas as shown in FIG. 10. As shown in FIGS. 4 and 8, the area B is a division area serving as an object of an analysis based on equivalent circuit approximation.

For example, there is a case in which the system becomes complex so that the heat flow also becomes complicated as well. In such a case, if the division area B which is a division area serving as an object of an analysis based on equivalent circuit approximation is not further divided into fraction areas, it may be difficult to express the internal heat flow in terms of the thermal resistance matrix [R] or the admittance matrix [Y].

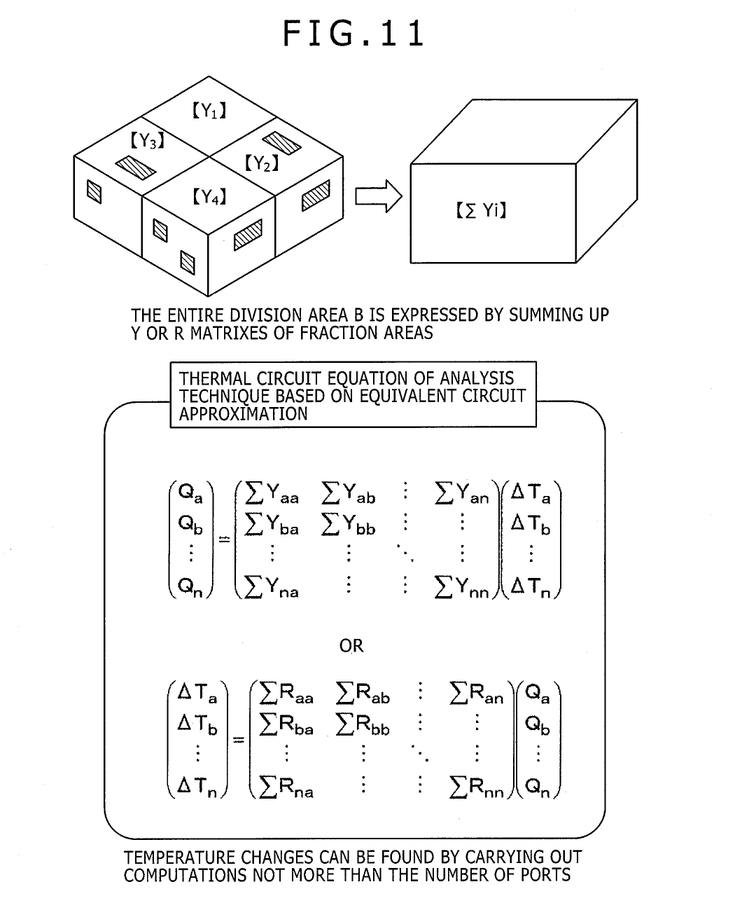

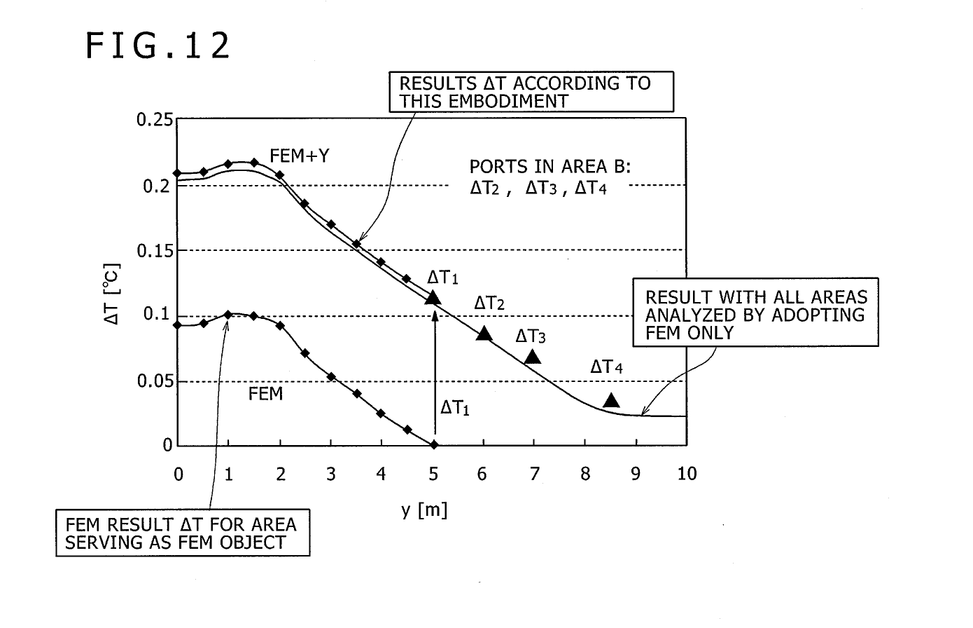

In such a case, if the division area B which is a division area serving as an object of an analysis based on equivalent circuit approximation is further divided into fraction areas as shown in FIG. 10, the precision of the analysis may be improved. FIG. 11 is a diagram referred to in the following description of an outline of an analysis technique based on equivalent circuit approximation for a case in which the division area B is further divided into fraction areas.

As shown in FIG. 11, for every fraction area i, the thermal resistance matrix [R]ᵢ or the admittance matrix [Y]ᵢ is found in the same way as the way described so far. Then, the matrixes [R]ᵢ or [Y]ᵢ are summed up to generate a synthesized matrix Σ[R]ᵢ or Σ[Y]ᵢ respectively. Thus, this embodiment implements a method for finding the thermal resistance matrix [R] or the admittance matrix [Y] for the entire system of the division area B which is a division area serving as an object of an analysis based on equivalent circuit approximation. The synthesized matrix is then used for finding the temperature difference ΔT_{B} of every port on the basis of the thermal equivalent circuit equation [ΔT]=[R][Q] in the same way as the way described so far.

In this case, however, the ports exist not only on the boundary for an FEM or BEM object area (the area A) but also on the boundary between the fraction areas of the area B which is a division area serving as an object of an analysis based on equivalent circuit approximation.

In addition, since the division area B is divided into fraction areas, the preparation 15-1 also includes processing such as setting related to the division of the division area into fraction areas and the division of the division area into fraction areas in addition to the preparations for the creation of a computation model of the relevant area and the mesh generation.

In this case, as an index used for dividing the division analysis area into the fraction analysis areas, for a division analysis area used as the object of an analysis carried out by adoption of the technique based on equivalent circuit approximation, if the division analysis area is divided so that the number of fraction area division lines approximately perpendicular to the direction of a main heat flow from an inflow portion to an outflow portion of main heat is equal to or greater than the number of fraction area division lines approximately parallel to the direction of the main heat flow, the precision can be expected to further increase.

As described above, in accordance with this embodiment, if the number of ports in the area B which is a division area serving as an object of an analysis based on equivalent circuit approximation is increased, it is possible to increase the number of evaluation points for internal temperature changes and also the precision proportionally to the increase of the port count

In addition, at that time, a result obtained by actually making use of the embodiment is shown in FIG. 12. It is possible to verify that the result obtained by making use of the embodiment agrees with a result of computation carried out on the entire system by adoption of the FEM with errors within a range of 10%. In this case, however, the processing flows from the FEM analysis to the analysis based on equivalent circuit approximation. Nevertheless, the order of the analyses can be reversed as is the case with the second embodiment.

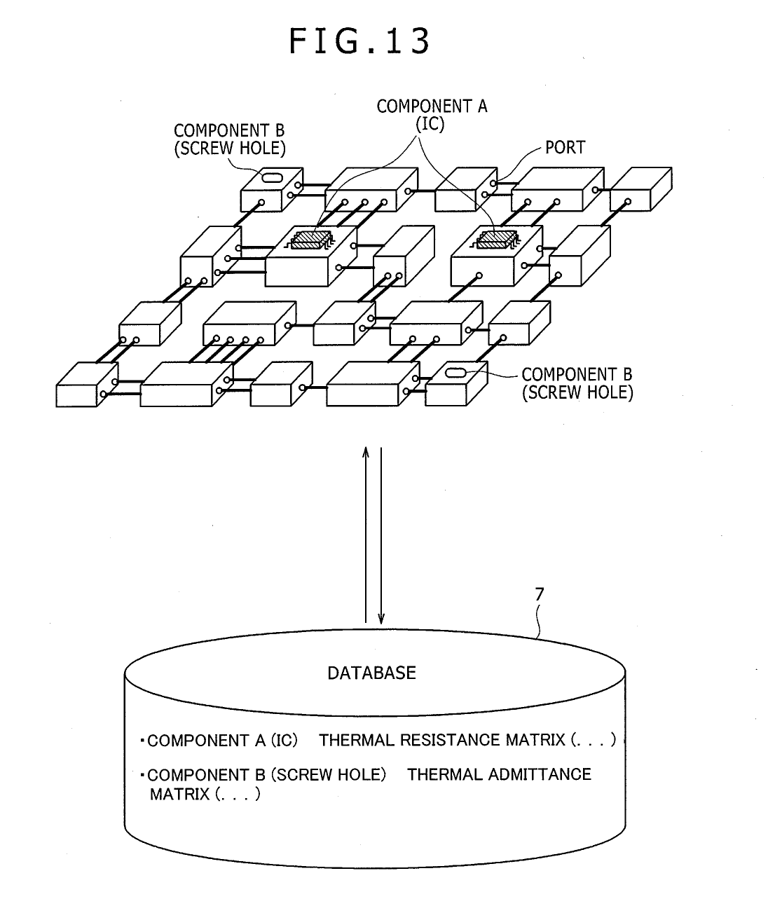

Next, a fourth embodiment of the present invention is explained by referring to FIG. 13. In this case, with regard to an index for dividing a division analysis area into fraction analysis areas or with regard to a unit of the fraction analysis area, the embodiment is characterized in that the division analysis area is divided into fraction analysis areas by making use of a component or a component including its peripherals as a unit of one fraction analysis area or the division analysis area is divided into fraction analysis areas each having an unchanging shape and fraction analysis areas each having a changeable shape.

That is to say, let a division analysis area be divided into fraction analysis areas with component units like ones shown in FIG. 13 taken as a basis. In this case, after the thermal resistance matrix [R] or the admittance matrix [Y] has been once computed for every component, the thermal resistance matrix [R] or the admittance matrix [Y] is stored in a database for every component. Thus, if the same component is mounted, it is possible to expect that the analysis of its area can be carried out at a very high speed.

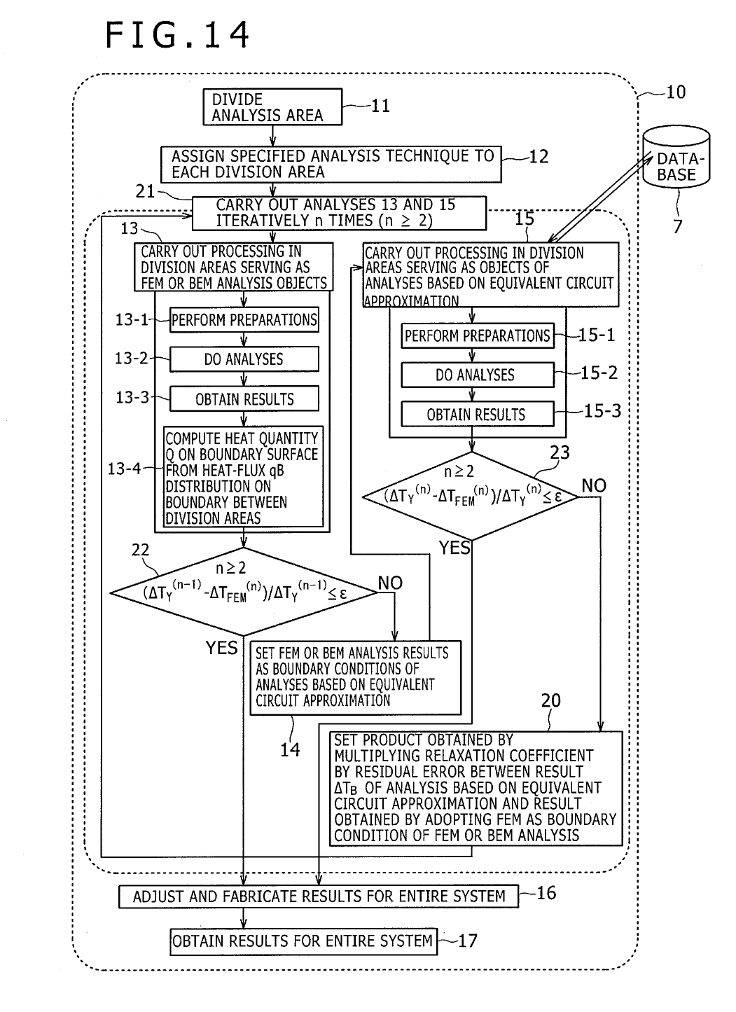

Next, a fifth embodiment of the present invention is explained by referring to FIG. 14. As explained earlier in the descriptions of the first and second embodiments, the processing 13 in a division area serving as an object of the FEM or BEM analysis is combined with the processing 15 in a division area serving as an object of an analysis based on equivalent circuit approximation to form a flow of a combined analysis. The fifth embodiment is characterized in that the combined analysis comprising the processing 13 in a division area serving as an object of the FEM or BEM analysis and the processing 15 in a division area serving as an object of an analysis based on equivalent circuit approximation is carried out as iterative computation processing 21 implemented by performing the combined analysis, which comprises the processing 13 in a division area serving as an object of the FEM or BEM analysis and the processing 15 in a division area serving as an object of an analysis based on equivalent circuit approximation, repeatedly at least two times.

FIG. 14 shows the processing flow of this embodiment. The computation processing 21 is implemented by performing the combined analysis repeatedly at least two times. As described above, the combined analysis comprises the processing 13 in a division area serving as an object of the FEM or BEM analysis and the processing 15 in a division area serving as an object of an analysis based on equivalent circuit approximation. On the basis of the following relations, the computation processing also determines whether the iterative computation processing is to be continued or stopped.

(ΔT_{Y}⁽ⁿ⁻¹⁾−ΔT_{FEM}⁽ⁿ⁾/ΔT_{Y}⁽ⁿ⁻¹⁾≦ε Determination 22

or

(ΔT_{Y}⁽ⁿ⁾−ΔT_{FEM}⁽ⁿ⁾/ΔT_{Y}⁽ⁿ⁾≦ε Determination 23

In the above relations, symbol ΔT_{Y} denotes a temperature change of analysis results of the processing 15 in a division area serving as an object of an analysis based on equivalent circuit approximation whereas symbol ΔT_{FEM} denotes a temperature change of analysis results of the processing 13 in a division area serving as an object of the FEM or BEM analysis. Superscript (n) is the number of iterations. That is to say, differences and errors between results of the two techniques are evaluated. In addition, symbol ε denotes a criterion value used for determining whether the iterative computation processing is to be continued or stopped. The criterion value can be a value prepared in advance in the system or a value specified by the user itself. It is nice to make use of a criterion value smaller than 1. For example, ε=0.1 or ε=10%. In this case, however, the analysis-model creation and the mesh creation are carried out only for the first iteration. That is to say, the analysis-model creation and the mesh creation are carried out by assuming that n=1. In other words, the analysis-model creation and the mesh creation are carried out only once and not required for the remaining iterations following the first one. As described above, the analysis-model creation and the mesh creation are included in the analysis preparation processing 13-1 of the processing 13 in a division area serving as an object of the FEM or BEM analysis and the analysis preparation processing 15-1 of the processing 15 in a division area serving as an object of an analysis based on equivalent circuit approximation.

Thus, in accordance with this embodiment, if there is a difference between results of the processing 13 in a division area serving as an object of the FEM or BEM analysis and the processing 15 in a division area serving as an object of an analysis based on equivalent circuit approximation or in other cases, the iterative computation can be carried out. Accordingly, the reliability of the computation results can be improved. In addition, since the computation can be stopped at a point of time at which the difference is determined to have been converged within a specified likelihood, no unnecessary computations are carried out.

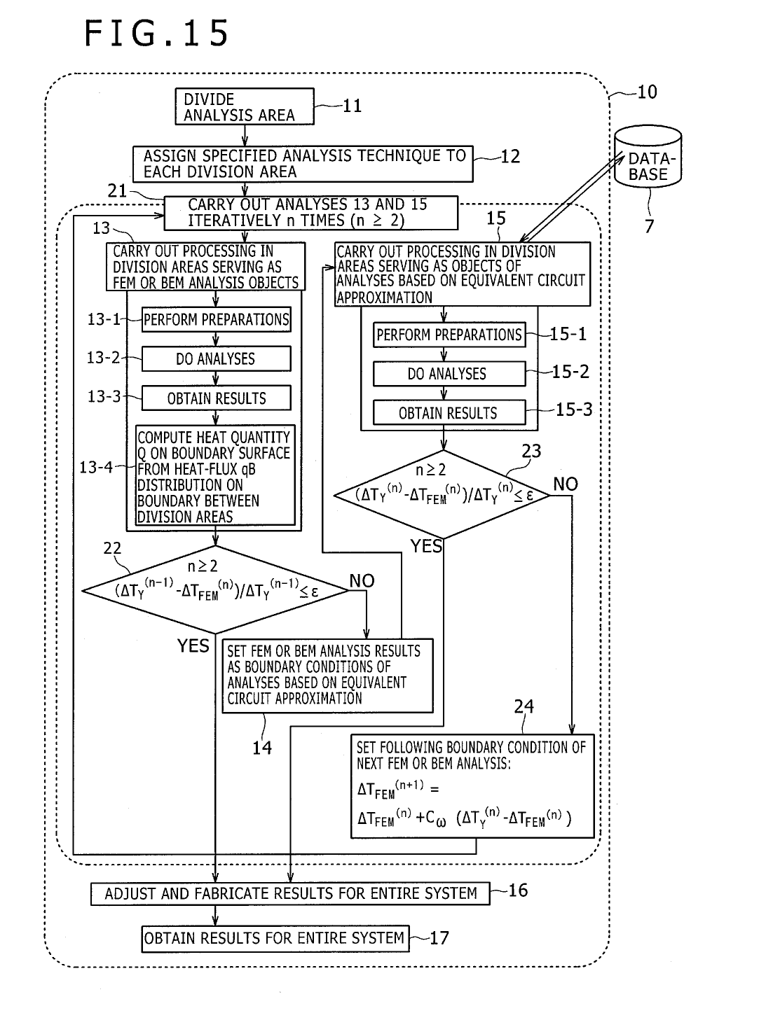

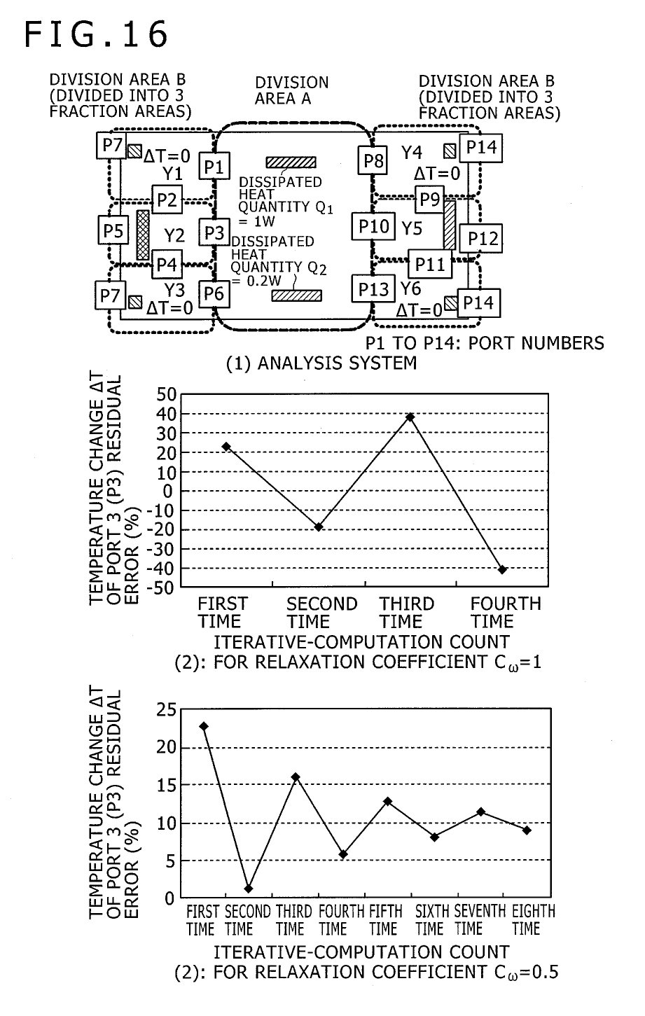

Next, a sixth embodiment of the present invention is explained by referring to FIGS. 15 and 16. In particular, the sixth embodiment is characterized in that processing 20 of the fifth embodiment is replaced with processing 24. To put it concretely, the processing 24 is carried out in order to set a boundary condition of the FEM or BEM analysis on the basis of the following equation:

ΔT_{FEM}⁽ⁿ⁺¹⁾=ΔT_{FEM}⁽ⁿ⁾+C_{ω}·(ΔT_{Y}⁽ⁿ⁾−ΔT_{FEM}⁽ⁿ⁾) Determination 24

In the processing 20, a product is set by taking the result of an analysis based on equivalent circuit approximation as the boundary condition of an FEM or BEM analysis. The product is a product obtained by multiplying a relaxation coefficient C_{ω} by a residual error between an analysis result ΔT_{Y} on the area boundary and a result ΔT_{FEM} of an analysis adopting the FEM. The analysis result ΔT_{Y} is a result of the processing 15 in a division area serving as an object of an analysis based on equivalent circuit approximation.

In this case, however, the relaxation coefficient C_{ω} satisfies the following relation: C_{ω}<1. That is to say, in accordance with this method, the result gradually converges by carrying out the processing 13 in a division area serving as an object of the FEM or BEM analysis and the processing 15 in a division area serving as an object of an analysis based on equivalent circuit approximation. Results obtained by actually making use of the embodiment are shown in FIG. 16. It is possible to verify that the results obtained by making use of the embodiment agree with results of computation. If there is a difference between results of the processing 13 in a division area serving as an object of the FEM or BEM analysis and the processing 15 in a division area serving as an object of an analysis based on equivalent circuit approximation or in other cases, for the relaxation coefficient C_{ω} equal to 1, the solution (ΔT) undesirably diverges or oscillates. For the relaxation coefficient C_{ω} equal to 0.5 (<1), on the other hand, the solution is gradually approaching to a true value so that the solution converges in a stable manner. That is to say, in accordance with this embodiment, if there is a difference between results of the processing 13 in a division area serving as an object of the FEM or BEM analysis and the processing 15 in a division area serving as an object of an analysis based on equivalent circuit approximation or in other cases, the solution can be expected to converge in a stable manner.

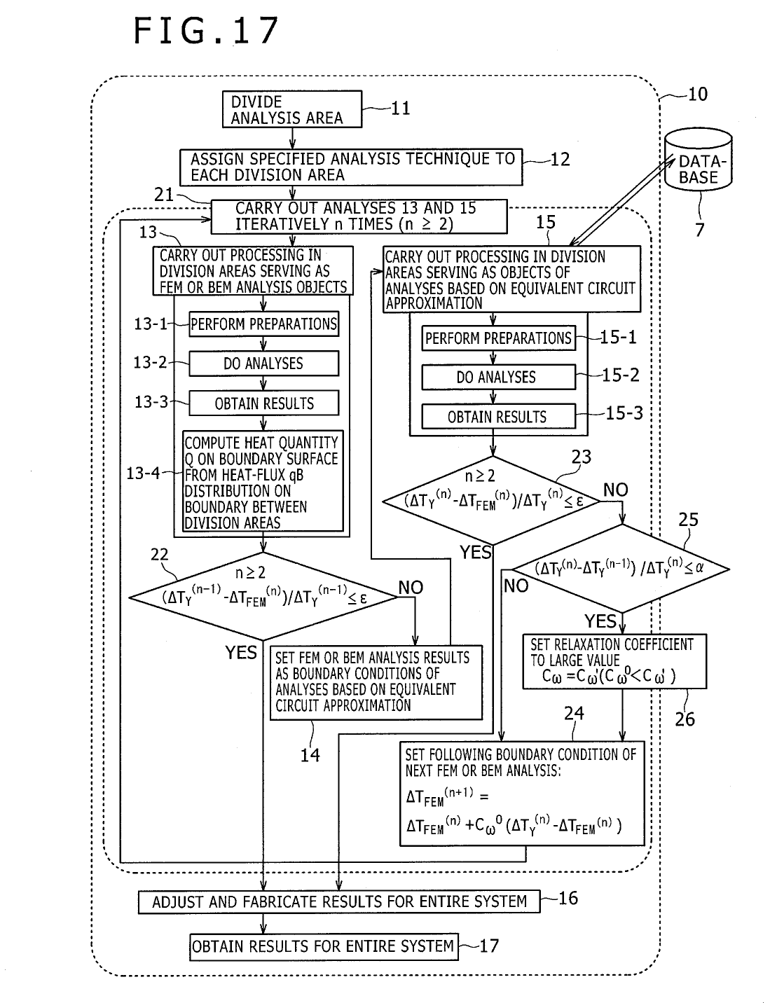

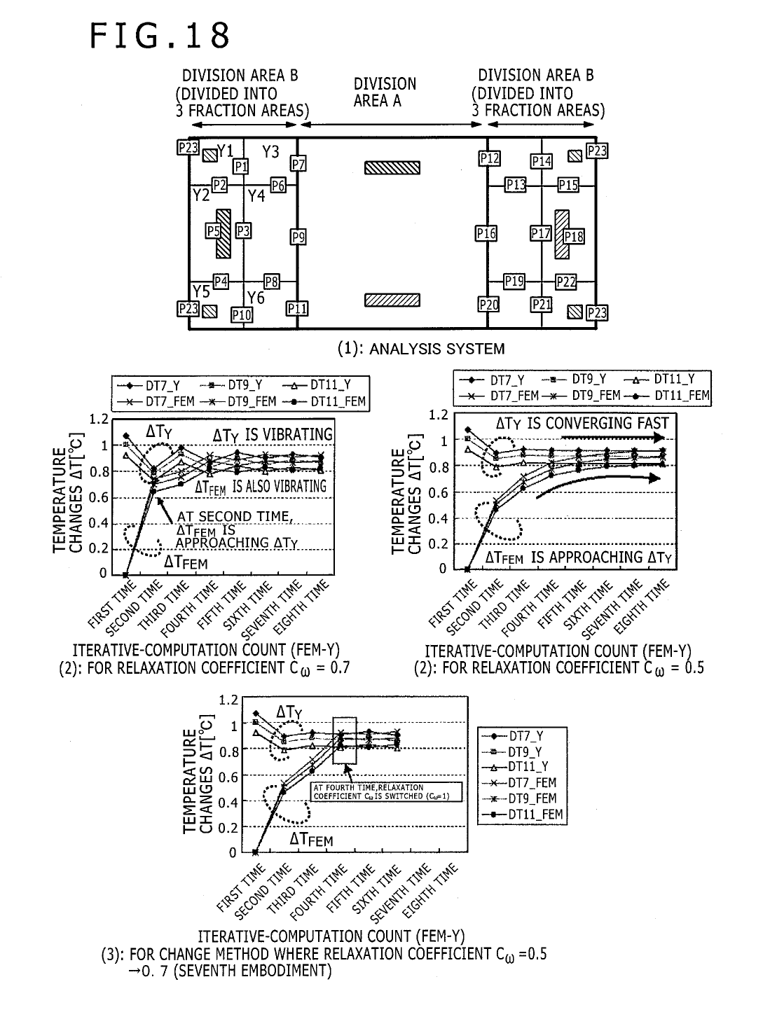

Next, a seventh embodiment of the present invention is explained by referring to FIGS. 17 and 18. In comparison with the sixth embodiment, the seventh embodiment is characterized in that the value of the relaxation coefficient C_{ω} is changed in the course of processing 22 carried out to determine whether the iterative computations are to be continued or stopped on the basis of a product obtained by multiplying the relaxation coefficient C_{ω} (<1) by a residual error between an analysis result ΔT_{Y} on the area boundary and a result ΔT_{FEM} of an analysis adopting the FEM. The analysis result ΔT_{Y} is a result of the processing 15 in a division area serving as an object of an analysis based on equivalent circuit approximation. As shown in FIG. 18 (1), the smaller the value of the relaxation coefficient C_{ω}, the more stable and the more reliable the manner in which the solution converges. Since the number of required iterations is large, however, the computation time is undesirably very long. As shown in FIG. 18 (2), on the other hand, if the relaxation coefficient C_{ω} is increased to a value within a range of C_{ω}<1, by carrying out the processing 13 in a division area serving as an object of the FEM or BEM analysis and the processing 15 in a division area serving as an object of an analysis based on equivalent circuit approximation, the result converges fast but the solution oscillates inevitably.

Thus, in this embodiment, with attention paid to the fast convergence of the result of the processing 15 in a division area serving as an object of an analysis based on equivalent circuit approximation, on the basis of processing 25 to determine whether or not to change the value of the relaxation coefficient C_{ω} in accordance with a relation given below, a residual error of an analysis based on the equivalent circuit approximation is found and, if the value of the residual error is not greater than a value a determined in advance, processing 26 to change the set value of the relaxation coefficient C_{ω} is carried out again.

(ΔT_{Y}⁽ⁿ⁾−ΔT_{Y}⁽ⁿ⁻¹⁾)/ΔT_{Y}⁽ⁿ⁾≦α Determination 25

After the determination described above, however, the value of the relaxation coefficient C_{ω} can be 1 (that is, C_{ω}=1). That is to say, the value of the relaxation coefficient C_{ω} can be set to 1. FIG. 17 shows the processing flow of this embodiment. In addition, results obtained by actually making use of the embodiment are shown in FIG. 18 (3). It is possible to verify that the results obtained by making use of the embodiment agree with results of computation. Initially, the value of the relaxation coefficient C_{ω} is set to 0.5, that is, C_{ω}=0.5 in order to let the solution converge in a stable manner. If the result of the processing 23 carried out to determine whether the iterative computations are to be continued or stopped indicates “a relation of being not greater than,” the value of the relaxation coefficient C_{ω} is changed to a set value of 1.0, that is, C_{ω}=1.0, making it obvious that the convergence is being accelerated. Thus, in accordance with this embodiment, even if there is a difference between results of the processing 13 in a division area serving as an object of the FEM or BEM analysis and of the processing 15 in a division area serving as an object of an analysis based on equivalent circuit approximation or in other cases, the solution can be expected to converge fast in a stable manner.

Next, an eighth embodiment of the present invention is explained. The description given so far has explained a combined analysis comprising the processing 13 in a division area serving as an object of the FEM or BEM analysis and the processing 15 in a division area serving as an object of an analysis based on equivalent circuit approximation by focusing on a heat transfer analysis. However, the eighth embodiment is characterized in that a heat stress can be computed in the same way by carrying out the combined analysis comprising the processing 13 in a division area serving as an object of the FEM or BEM analysis and the processing 15 in a division area serving as an object of an analysis based on equivalent circuit approximation. The general equation of the heat stress is given as follows:

σ=E·εᵣ=E·α·ΔT

In the above equation, symbols E, εᵣ and α denote Young's modulus, a heat strain and a linear expansion coefficient respectively. The eighth embodiment finds the temperature change ΔT in the same way as the embodiments explained so far. The heat stress is computed as a heat stress perpendicular to the boundary surface in accordance with the above equation. In general, the heat-stress analysis requires a three-dimensional analysis to be carried out, entailing a cost increase. By making use of the eighth embodiment, however, a high-precision heat-stress analysis can be carried out.

Next, a ninth embodiment of the present invention is explained. The description given so far has explained a combined analysis comprising the processing 13 in a division area serving as an object of the FEM or BEM analysis and the processing 15 in a division area serving as an object of an analysis based on equivalent circuit approximation by focusing on a heat transfer analysis. However, the ninth embodiment is characterized in that, in the same way as the heat transfer analysis, the ninth embodiment carries out an analysis of a physical quantity having a field describable by scalar potentials. For example, an electric field is a typical one. If the field can be described by scalar potentials, an area like the one according to the present invention is divided into division areas and linearity obtained by combining the division areas is sustained so that, basically, the present invention is conceivably applicable.

Next, a tenth embodiment of the present invention is explained by referring to FIG. 3. This embodiment is characterized in that, if a PC cluster, a multi-core PC or a multi-thread PC is used as a computer 2 shown in FIG. 3, a division area and a computation for the division area are assigned to every PC, every core or every thread in order to increase the speed of the entire computation. The more mutually independent the computations, the bigger the effect provided by the embodiment. Thus, for example, if the computations to find the thermal resistance matrix [R] or admittance matrix [Y] of fraction areas for the area B serving as an object of the analysis based on equivalent circuit approximation are carried out in a multi-processing environment as is the case with this embodiment, the speed of the computation will be increased substantially.

### DESCRIPTION OF REFERENCE NUMERALS

1: Numerical analysis flow of a first embodiment of the invention
2: Computer system
3: Input section
4: Output section
5: Display section
6: Recording section
7: Database
8: Second computer system
9: Network
10: Program executed to perform a numerical analysis according to the invention
11: Area division
12: Assignment of analysis techniques to areas
13: Processing in a division area serving as an FEM or BEM analysis object
14: Processing to set FEM or BEM analysis results as boundary conditions of analyses based on equivalent circuit approximation
15: Processing in a division area serving as an object of an analysis based on equivalent circuit approximation
16: Fabrication/adjustment processing of a temperature change distribution
17: Expanded results output and displayed on the entire system
18: User input section
19: Port
20: Processing to reset results of an analysis based on equivalent circuit approximation as boundary conditions of an FEM or BEM analysis
21: Iterative computation processing implemented by carrying out a combined analysis, which comprises the processing 13 in a division area serving as an object of the FEM or BEM analysis and the processing 15 in a division area serving as an object of an analysis based on equivalent circuit approximation, at least two times
22 and 23: Processing to determine whether iterative computation is to be continued or stopped
24: Processing to set boundary conditions of an FEM or BEM analysis
25: Processing to determine whether or not the value of a relaxation coefficient C_{ω} is to be changed
26: Processing to determine whether or not the value of a relaxation coefficient C_{ω} is to be changed

1. A numerical analysis system for heat transfers or heat stresses, the numerical analysis system comprising,
dividing an analysis area into at least two division areas;
analyzing at least one of the division areas by adoption of a finite element method or a boundary element method; and
carrying out an analysis by adoption of a technique based on equivalent circuit approximation for at least one of the other division areas.

2. The numerical analysis system according to claim 1, wherein in accordance with a method for carrying out an analysis by adoption of the technique based on equivalent circuit approximation, in the case of a heat-transfer analysis:
the thermal resistance R of the analysis area or the admittance Y (=R⁻¹) which is the reciprocal of the thermal resistance R, is found in advance; and
then, a temperature change ΔT on a boundary between the division areas included in the analysis area is computed on the basis of a thermal equivalent circuit equation (ΔT=RQ) from a heat quantity Q on the boundary between the division areas included in the analysis area.

3. The numerical analysis system according to claim 2, wherein
in accordance with a method for finding the thermal resistance R of the analysis area or the admittance Y (=R⁻¹) which is the reciprocal of the thermal resistance R, in advance:
if the boundary between the division areas included in the analysis area has at least two locations through which a heat quantity flows out and flows in or at least two locations at which temperature changes are to be measured,
a thermal resistance matrix [R] of the analysis area or an admittance matrix [Y] (=[R]⁻¹) which is the inverse matrix of the thermal resistance matrix [R], is found in advance; and
then, a temperature change sequence [ΔT] on the boundary between the division areas included in the analysis area is computed on the basis of a thermal equivalent circuit equation ([ΔT]=[R][Q]) from a heat quantity sequence [Q] on the boundary between the division areas included in the analysis area.

4. The numerical analysis system according to claim 1, wherein,
in accordance with a method for carrying out an analysis by adoption of the technique based on equivalent circuit approximation, in the case of a heat-stress analysis:
after a temperature change ΔT on the boundary between the division areas included in the analysis area or a temperature change sequence [ΔT] on the boundary between the division areas included in the analysis area has been computed on the basis of the thermal equivalent circuit equation according to claim 2,
the temperature changes are further used for finding a stress generated by thermal expansion or thermal contraction.

5. The numerical analysis system according to claim 1, wherein
in accordance with a method for dividing the analysis area into at least two division areas:
the analysis area is divided into a division area having an unchanging shape and a division area having a changeable shape;
the division area having an unchanging shape is taken as an object of an analysis adopting the technique based on equivalent circuit approximation; and
the division area having a changeable shape is taken as an object of an analysis adopting the finite element method or the boundary element method.

6. The numerical analysis system according to claim 1, wherein
in accordance with a method for dividing the analysis area into at least two division areas:
the analysis area is divided into a division area having at least one heat source and a division area having no heat source;
the division area having no heat source is taken as an object of an analysis adopting the technique based on equivalent circuit approximation; and
the division area having at least one heat source is taken as an object of an analysis adopting the finite element method or the boundary element method.

7. The numerical analysis system according to claim 2, wherein
the value of a thermal resistance R obtained for the analysis area or the value of a thermal resistance matrix [R] obtained for the analysis area, or the value of an admittance Y which is the reciprocal of the thermal resistance R or the value of an admittance matrix [Y] which is the inverse matrix of the thermal resistance matrix [R] is found once and then stored in a database (DB) for later utilizations.

8. A numerical analysis system, for heat transfers or heat stresses, the numerical analysis system comprising,
dividing an analysis area into at least two division areas;
analyzing at least one of the division areas by adoption of a finite element method or a boundary element method; and
carrying out an analysis by adoption of a technique based on equivalent circuit approximation for at least one of the other division areas, wherein
in accordance with a method for carrying out an analysis by adoption of the technique based on equivalent circuit approximation:
the division area taken as an object of an analysis adopting the technique based on equivalent circuit approximation is further finely divided into a plurality of fraction areas;
with regard to each of the further finely divided fraction areas, a thermal resistance R or a thermal resistance matrix [R], or an admittance Y which is the reciprocal of the thermal resistance R or an admittance matrix [Y] which is the inverse matrix of the thermal resistance matrix [R] is computed in accordance with a method used for the analysis area according to claim 2; and
the computed value of the thermal resistance R, the value of the thermal resistance matrix [R], the value of the admittance Y which is the reciprocal of the thermal resistance R and the value of the admittance matrix [Y] which is the inverse matrix of the thermal resistance matrix [R] are synthesized in order to find, for the division area serving as an object of the analysis carried out by adoption of the technique based on equivalent circuit approximation, a thermal resistance R or a thermal resistance matrix [R], or an admittance Y which is the reciprocal of the thermal resistance R or an admittance matrix [Y] which is the inverse matrix of the thermal resistance matrix [R].

9. The numerical analysis system according to claim 8, wherein
in accordance with a method for further dividing the division area taken as an object of an analysis carried out by adopting the technique based on equivalent circuit approximation into a plurality of fraction areas:
with regard to either of an index and a unit which are used for dividing the division area into the fraction areas, the division area is divided by making use of a component or a component including its peripherals as a unit of one fraction area or the division area is divided into fraction areas each having an unchanging shape and fraction areas each having a changeable shape.

10. The numerical analysis system according to claim 8, wherein
in accordance with a method for further dividing the division area taken as an object of an analysis carried out by adopting the technique based on equivalent circuit approximation into a plurality of fraction areas:
as the index used for dividing the division area into the fraction areas, with regard to the division area taken as an object of an analysis carried out by adopting the technique based on equivalent circuit approximation, the number of fraction area division lines approximately perpendicular to the direction of a main heat flow from an inflow portion to an outflow portion of main heat is set to a value equal to or greater than the number of fraction area division lines approximately parallel to the direction of the main heat flow.

11. The numerical analysis system according to claim 1, wherein
in accordance with a method for dividing an analysis area into at least two division areas, analyzing at least one of the division areas by adoption of a finite element method or a boundary element method and carrying out an analysis by adoption of the technique based on equivalent circuit approximation for at least one of the other division areas:
an analysis result obtained in any specific one of the division areas is passed on across a boundary between the specific division area and the other division area as a boundary value of the next analysis in the other division area and combined analyses are carried out so as to assure preservation and consistency of physical quantities.

12. The numerical analysis system according to claim 1, wherein
in accordance with a method for dividing an analysis area into at least two division areas, analyzing at least one of the division areas by adoption of a finite element method (FEM) or a boundary element method (BEM) and carrying out an analysis by adoption of the technique based on equivalent circuit approximation for at least one of the other division areas:
first, a division area to be analyzed by adoption of the finite element method or the boundary element method, a heat-flux (q) distribution and a temperature-change (ΔT) distribution in the inside and on the boundary of the division area serving as an object of the finite element method or the boundary element method are found by setting a temperature change ΔT on the boundary with a division area to be analyzed by adoption of the technique based on equivalent circuit approximation to 0 (that is, ΔT=0) in an initial setting operation;
a heat quantity Q_{B} of the boundary with the division area to be analyzed by adoption of the technique based on equivalent circuit approximation is computed on the basis of the heat-flux (q) distribution and the temperature-change (ΔT) distribution from the heat-flux (q) distribution;
then, a temperature change ΔT_{B} on the boundary of the division area is computed from the heat quantity Q_{B} of the boundary on the basis of a thermal equivalent circuit equation ([ΔT]=[R][Q]) for a division area to be analyzed by adoption of the technique based on equivalent circuit approximation; and
the values of a temperature-change (ΔT_{B}) distribution on the boundary of the division area are added to a ΔT distribution obtained by carrying out an analysis based on the finite element method or the boundary element method with the temperature change ΔT on the boundary set to 0 (that is, ΔT=0) in an initial setting operation, in order to find a temperature-change (ΔT) distribution.

13. A numerical analysis system according to claim 1, wherein
in accordance with a method for dividing an analysis area into at least two division areas, analyzing at least one of the division areas by adoption of a finite element method (FEM) or a boundary element method (BEM) and carrying out an analysis by adoption of the technique based on equivalent circuit approximation for at least one of the other division areas:
a heat quantity Q calculated from all heat sources existing in the entire system is set as a heat quantity Q on a boundary between a division area to be analyzed by adoption of the finite element method or the boundary element method and a division area to be analyzed by adoption of the technique based on equivalent circuit approximation;
a temperature change ΔT on the boundary of the division area is computed from the heat quantity Q on the basis of a thermal equivalent circuit equation (ΔT=RQ) for the division area serving as an object to be analyzed by adoption of the technique based on equivalent circuit approximation;
then, the temperature change ΔT on the boundary is taken as an initial condition; and
a heat-flux (q) distribution and a temperature-change (ΔT) distribution in the inside and on the boundary of a division area serving as an object of the finite element method or the boundary element method are computed.

14. The numerical analysis system according to claim 11, wherein
in accordance with a method for passing on an analysis result obtained in any specific one of the division areas across a boundary between the specific division area and the other division area as a boundary value of the next analysis in the other division area and carrying out combined analyses so as to assure preservation and consistency of physical quantities:
iterative computations are repeatedly performed at least two times to carry out a combined analysis combining an analysis adopting the finite element method or the boundary element method with an analysis based on the equivalent circuit approximation.

15. The numerical analysis system according to claim 14, wherein
in accordance with a method for iteratively carrying out a combined analysis combining an analysis adopting the finite element method or the boundary element method with an analysis based on the equivalent circuit approximation at least two times:
a residual error of the most recent temperature change ΔT on a boundary, the temperature change ΔT found by adoption of techniques for division areas, is found; and
a sum obtained by adding a product obtained by multiplying the residual error by a relaxation coefficient ω (≦1) to a value of an immediately previous analysis or an analysis preceding the immediately previous analysis is passed on as a boundary value of the next analysis.

16. The numerical analysis system according to claim 15, wherein
in accordance with a method for finding a residual error of the most recent temperature change ΔT on a boundary, the temperature change ΔT found by adoption of techniques for division areas, and passing on a sum obtained by adding a product obtained by multiplying the residual error by a relaxation coefficient ω (≦1) to a value of an immediately previous analysis or an analysis preceding the immediately previous analysis as a boundary value of the next analysis:
the value of the relaxation coefficient ω is changed in the course of the iterative computations to carry out the combined analysis.

17. The numerical analysis system according to claim 16, wherein
in accordance with a method for changing the value of the relaxation coefficient ω in the course of the iterative computations to carry out the combined analysis:
the value of the relaxation coefficient ω is changed in the course of the iterative computations so as to set the relaxation coefficient ω to a small value (ω≦0.5) when the number of aforementioned iterative computations is small or a large value (0.5<ω≦1.0) when the number of aforementioned iterative computations increases.

18. The numerical analysis system according to claim 1,
wherein, if a PC cluster, a multi-core PC or a multi-thread PC is used as means for carrying out analysis computations, a division area and computation for every division area are assigned to each PC, each core or each thread in order to raise the speed of the whole computations.

19. A numerical analysis system according to claim 1,
wherein, for a heat-transfer or heat-stress analysis, even in the case of a quantity other than a physical quantity serving as an analysis object, in the same way as the heat analysis, a physical quantity having a field describable by a scalar potential is analyzed.

20. A numerical analysis system according to claim 1, wherein
in accordance with a method for dividing an analysis area into at least two division areas or in accordance with a method according to claim 8 for further finely dividing the division area taken as an object of an analysis executed by adoption of the technique based on equivalent circuit approximation into a plurality of fraction areas:
with regard to division of the analysis area into division areas and division of the division area into fraction areas, a user interface function to be used by a user carrying out analyses to enter or set information is provided.
